(19) United States
(12) Patent Application Publication
(10) Pub. No.: US 2025/0276728 A1
(43) Pub. Date: Sep. 4, 2025

(54) Child Safety Apparatus For Shopping Carts

(71) Applicant: Cassandra Jean Stetson, Robertsdale, AL (US)

(72) Inventor: Cassandra Jean Stetson, Robertsdale, AL (US)

(21) Appl. No.: 18/594,220

(22) Filed: Mar. 4, 2024

(51) Int. Cl. B62B 3/14

(52) U.S. Cl. CPC B62B 3/1452

(57) ABSTRACT

Child safety apparatus and method of security are disclosed for providing child restraint while riding in a shopping cart seat. This invention was carefully constructed to provide comfort to the child with a luxury performance textile fabric, antimicrobial, compact, with a system of a releasable attachment mechanism using the preferred method for child safety, known as the LATCH system.

### FIELD

The present invention relates to child safety. More particularly, the present invention relates to a portable child safety apparatus for restraining a child seated in a shopping cart seat, so that the child is safely and comfortably secured to the shopping cart.

### BACKGROUND

Safeguarding children takes priority over any other matter during a shopping trip. There are many hazards that a child can fall victim to. For example, a child could succumb to stranger abductions or a fall from a shopping cart. A caretakers' responsibility is to prevent all threats from occurring while in their care. The problem with most shopping carts is that they do not provide adequate safety for our children. 24,000 children are treated for shopping cart related accidents per year. 78% of these injuries are head and neck related. Abductions have also been attempted by the perpetrator lifting the child up and out of the seat while the caretaker has turned away.

Shopping carts are usually equipped with some type of restraint with a plastic quick release clip. They consist of two straps secured to the back of the shopping cart seat and meant to wrap around the front of the child and buckled together at the chest. However, most restraints provided have not been properly maintained, and the plastic quick release buckles have been broken, missing, or malfunctioning. Even when a conventional shopping cart has the seat belt properly functioning, a stranger can easily disengage the quick release buckle and simply abduct the child. An active toddler can break free from the seat belt and fall out on his own even while the provided seating restraint is implemented. While testing different carts with an average toddler, it took 2.5 seconds for her to stand up in the seat with only the restraint made available. The restraints equipped by most store chains are simply not good enough to ensure the safety of the children for which they were intended. Caretakers count on these restraints, and although carts are similar, there are inconsistencies and deviations, making some available aftermarket products difficult to fit properly. Some available products are bulky, rigid, and even have an age restriction. There is a need for an apparatus that is convenient, flexible, comfortable, and secure, that would be universally applicable. The objective is to provide a child restraint system with easy operation while still permitting security for the child.

### SUMMARY

Therefore, it is the objective of the present invention to provide a safety and restraint apparatus with ease of transport to solve the addressed problems.

To achieve the objective, and to exceed expectation, the present invention was carefully constructed with consideration to comfort for the child, with the addition of a luxury performance fabric, being compact and lightweight, all with a system of a releasable attachment mechanism using the preferred method for child safety with hooked end spring clips, commonly known as the LATCH system, to be secured at a lower anchor point of the vehicle.

The restraint means includes a waist portion which has first and second ends to be attached to the shopping cart seating area. The length of strapping extends over the waist of the child in a seated position. A second looped strap attached to said waist portion between the ends thereof, extends downwardly between the legs of said child and is attached to said shopping cart. Both the waist portions and center leg portions are adjustable in length provided by slide adjuster buckles to ensure snugness to hold the child in a seated position. The whole of this system is encased in a padded cover made of treated luxury textile performance fabric. This fabric is stain, odor, and moisture resistant, and antimicrobial, which makes this invention an easy to care for product with no need for disassembly, usually a process required to achieve cleanliness regarding consumer products intended for children.

The benefit of the hooked end spring clips is for ease of operation and provides security by means of the LATCH system for child's safety. The LATCH system, or lower anchors and tethers for children, is the preferred method of transportation safety and is used today on child car seats for vehicles. Parents and caretakers alike will benefit from the added safety of this distinct feature, and with peace of mind, knowing it is the foremost method of restraint used while traveling in a vehicle.

### BRIEF DESCRIPTION OF DRAWINGS

A preferred embodiment of the present invention will now be described with reference to an example thereof as illustrated in the accompanying drawings, in which:

FIG. 1 is a pictorial drawing illustrating the invention.

FIG. 2 is a transparent drawing illustrating the invention.

FIG. 3 is a pictorial view of a preferred latch mechanism.

FIG. 4 is a pictorial drawing illustrating a child utilizing the invention.

### DETAILED DESCRIPTION OF DRAWINGS

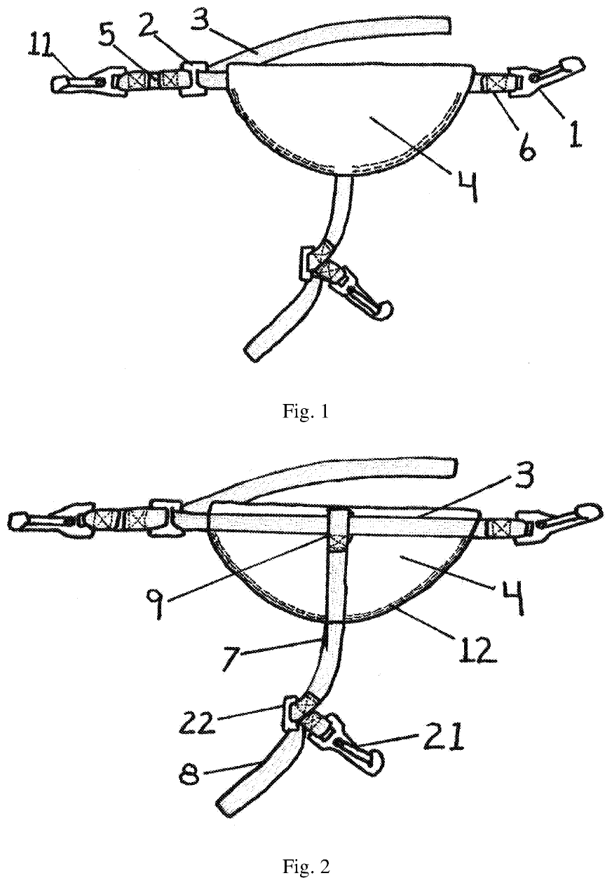

Referring now to FIG. 1, the pictorial drawing of the safety restraint apparatus is shown, comprising of a waist portion of strap material specifically of two parts, in whereas one part 3 being 33″ connected to the second part 5 being 7″ by means of a first adjustable slide buckle 2. Waist portion 3 passes freely through the first adjustable slide buckle 2 from one end, passes through the fabric cover 4, and is inserted through the first hooked end snap clip 1 by means of entrance of said device and sewn to itself securely. The method of securement at this connection 6 is by sewing repeatedly four times over itself and sealed to prevent unraveling. Second part of waist portion 5 of strap material connects through second hooked end snap clip 11 and adjustable slide buckle 2 at each end of said waist portion 5 strap material and securely attached to itself respectively by means of sewing repeatedly four times over itself, using the same method of securement as before, and sealed to prevent unraveling.

A more transparent view in FIG. 2 emphasizes the crotch portion of strap material comprising of two parts with one part 7 being 12″ connected by means of a second adjustable slide buckle 22 to the second part 8 being 14″. One end of the first part 7 is sewn securely to itself by the same method of securement after attaching to the second adjustable slide buckle 22 and sealed. The opposite end of crotch portion 7 of strap material is hung loosely and looped 9 over waist portion 3 of strap material and sewn to itself by same means of securement and hangs perpendicular to waist portion 3. The second part of crotch portion 8 of strap material passes through the second adjustable slide buckle 22 and is inserted through a third hooked end snap clip 21 by means of entrance and sewn to itself by same means of securement and sealed.

The whole embodiment of waist portion 3 and crotch portion 7 of strap material is encased in a padded luxury treated textile fabric cover 4 comprising of 11″ circumference, hemmed and folded into a semi-circular shape with ends of strap material 3,7 hanging through left, right, and down, with sections of cover 4 being sewn to itself comprising of double stitching 12 to prevent disassembly.

FIG. 3 illustrates the hooked end snap clip in considerable detail, as this invention comprises three of these said snap clips to be utilized in tandem as the preferred latch mechanism for this invention. This latch comprises of a spring-biased hooked end 13 to make connection with a lower anchor point within the vehicle structure and opposite end access point 19 being tethered by exampled strap material 14.

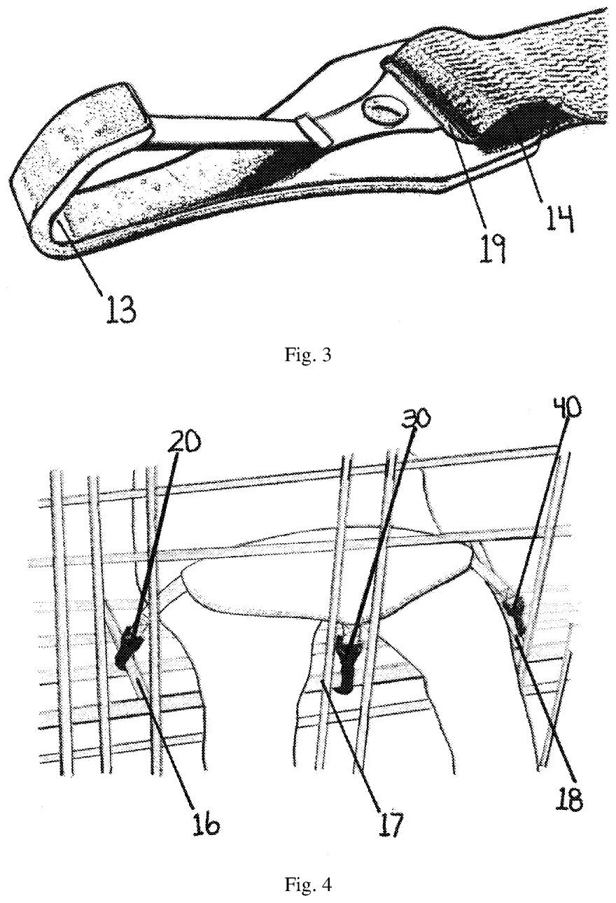

As FIG. 4 illustrates this invention being utilized with a shopping cart, the method and embodiment of this apparatus comprises of, and retains the advantage of, three hooked end snap clips 20,30,40 as this safety apparatus overcomes many shortcomings described in the background section of this application. When each snap clip 20,30,40 is engaged in a locked position onto a lower anchor point 16,17,18 of the structured vehicle, being said shopping cart, and not onto a higher point of the seat backing, it provides a method of securement for the child.

Now that the present invention has been described,

What is claimed is:

1. A child safety apparatus using the preferred method of transportation LATCH (Lower Anchors and Tethers for Children) system while in the seat of a shopping cart comprising:
a. A waist portion of strap material having two parts, with first and second part respectively attached through an adjustable slide buckle mechanism, the other said end extending through crotch portion loop strap, and both first and second ends respectively comprising of a LATCH hooked end snap clip; and
b. A crotch portion of strap material having two parts, with first and second part respectively attached through an adjustable slide buckle mechanism; the first part opposite end comprising of a closed loop fixed to said waist portion of strap material; the second part comprising of a LATCH hooked end snap clip extended perpendicular; and
c. The LATCH system of fastening the first and second waist latch devices being releasably securable to a wire portion of the shopping cart seat to anchor the child within, and the crotch latch device extended downward between the child's legs to be releasably securable to the lower middle wire portion of the shopping cart to anchor a child within the shopping cart.

2. A child safety restraint apparatus which is portable, compact, and easy to care for comprising:
a. A padded cover apparatus to encase the system of waist portion strap material extended through, and looped end crotch portion strap material extended downward through, comprising of fabric quilting sewn inside luxury fabric cover comprising; and
b. A stain resistant, water resistant, odor resistant, antimicrobial treated textile fabric cover.

3. A method of enhancing the safety of a seated child comprising the steps of:
a. Identifying a child seated in a vehicle, specifically a shopping cart seat; and
b. Applying a child safety restraint apparatus upon the child's lap; and
c. Connecting the hooked end snap clips from waist portion of strap material according to claim 1 to the closest portion of vehicle nearest child's hips; and
d. Connecting the hooked end snap clips from crotch portion of strap material according to claim 1 to the closest portion of vehicle between child's legs; and
e. Securing a proper fit by adjusting the strap materials from both waist and crotch portions by way of adjustable slide buckles respectively.
Wherein, a proper fit of anchoring a child in a shopping cart by means of tethers and anchors, secured at the hips with the use of the same hooked end snap clips used for transportation safety in automobiles, and fully adjustable to provide comfort for all children riding in a shopping cart seat, with ease of portability to carry by caretakers, this child safety apparatus for shopping carts will enhance security of children by providing safety from falls out of shopping cart seats and lessens the possibility of passerby abductions.
